(19) United States
(12) Patent Application Publication
(10) Pub. No.: US 2010/0107060 A1
(43) Pub. Date: Apr. 29, 2010

(54) SYSTEM, APPARATUS AND METHOD FOR GENERATING SCHEDULE DOCUMENT

(75) Inventor: Hiroaki ISHIZUKA, Ridgewood, NJ (US)

Correspondence Address: COOPER & DUNHAM, LLP, 30 Rockefeller Plaza, 20th Floor, NEW YORK, NY, 10112, US

(73) Assignees: RICOH COMPANY, LTD., TOKYO (JP); RICOH AMERICAS CORPORATION

(21) Appl. No.: 12/258,599

(22) Filed: Oct. 27, 2008

(51) Int. Cl. G06F 17/00

(52) U.S. Cl. 715/255

(57) ABSTRACT

Method, apparatus and system are provided for generating a schedule document based on mashup of data obtained from a plurality of different applications.

### TECHNICAL FIELD

This disclosure relates to an approach for generating a schedule document. In particular, the disclosure relates to a method, apparatus and system for generating a schedule document based on mashup of data obtained from a plurality of different applications.

### BACKGROUND

In the current information age, it has often been discussed that proliferation of information technology (IT) can lead to more convenience, efficiency, productivity, enjoyment, etc., in life. The extensive use and development of IT facilities in work environments and home environments has concomitantly been accompanied by increasing numbers of applications and other information or data sources.

The World Wide Web (WWW or the Web) is one of the popular means for obtaining and supplying information (that is, any type of content, including structured or unstructured data, text, video, graphics, still photos, audio, a combination of two or more types, etc.). For example, SaaS (Software as a Service) is the term used to refer to a popular mode of supplying software applications through the Web. Further, other content may be supplied via the Web as a service using SOA (Service-Oriented Architecture). While many such applications or Web services are currently available, data and information from disparate applications (or Web services or other sources) are not always, and moreover typically are not, supplied in the same format. When information or data from a plurality of applications and/or sources are required for a particular task, there is often a need for combining the information from the disparate sources into a coherent collection.

While IT tools and facilities can allow one to accomplish more even while remaining at one location, the current trend in our society, as facilitated by assorted new and/or improved technologies and modes of transportation, is for higher levels of mobility. For example, many people often find themselves traveling on business trips away from the office, although the frequency of such trips of course varies from one person to another person. For those who need to travel often, it would be appreciated that coordination of travel plans and accompanying schedule information is typically a time-consuming, but necessary, part of planning. Further, there is much information that can be collected regarding the destination that would make the travel or trip proceed more smoothly.

There is a need for a tool that can automatically collect and compile such information into a desired format, without requiring someone to unnecessarily spend a large amount of time performing information gathering tasks for each trip.

### BRIEF SUMMARY

This disclosure describes tools (in the form of systems, apparatuses and methodologies) that can automate the generation of a schedule document based on mashup of data obtained from a plurality of different applications.

In an aspect of this disclosure, authentication information of an authorized user is registered for the plural applications, and upon login by the authorized user, identification of the user is determined. The appropriate authentication information for the user and a specified date (such as the login date) are utilized to obtain appropriate schedule data for the user from the scheduler application and obtain other information from other application(s) for populating data items of the schedule document. The schedule document is generated by performing a mashup of the schedule data and the other information.

In another aspect of this disclosure, the user specifies or selects in advance (a) the desired format of the schedule document (for example, utilizing a document template as a starting point, and later saving the working template specifying the desired format, as the user's template), (b) the desired scheduler application and (c) other applications (or information/data sources), and such information, that is, (a) through (c), can be registered in a management table maintained by a management service. The information (a) through (c) can be maintained as separate items, or, as in another example, the user's template may specify the desired scheduler application and other applications. In another example, the schedule data stored by the scheduler application may include links to the additional applications, and the links are used to obtain information from the additional applications. When the user logs-in to the management service, the appropriate information identifying the user's template, the scheduler application and the additional applications are appropriately retrieved from the management table, based on the user identification obtained in the login.

In addition, authentication information for the scheduler application and/or for the other applications can be registered in the management table. For example, upon user login to the management service, pre-stored authentication information of the user can be automatically used (that is, without additional action by the user) to login to the scheduler application, and then the schedule data of the user is obtained from the scheduler application for a specified date. Likewise, registered authentication information of the user for the other applications can be automatically used to retrieve the different information from the other applications.

Additional features for automating the schedule document generation process can be optionally included.

As an example, location data can be extracted from the schedule data obtained from the scheduler application, and supplied to one (or more) of the additional applications to obtain location-based information from the application. The location information can be transmitted, for example, to a map application to obtain location-based information (e.g., a map, directions, traffic information, etc.) from the map application. As another example, the location information can be transmitted (along with a specified date) to a weather application to obtain weather information.

### BRIEF DESCRIPTION OF THE DRAWINGS

The features of the subject matter of this disclosure can be more readily understood from the following detailed description with reference to the accompanying drawings wherein:

FIG. 1 shows a block diagram of a system, according to an exemplary embodiment of this disclosure;

FIG. 2 shows an example of configuration of a management server according to the exemplary embodiment of FIG. 1;

FIG. 3 shows an example of configuration of a user terminal in the system shown in FIG. 1;

FIG. 4 shows a block diagram of a multi-function apparatus in the system of FIG. 1;

FIG. 5 shows an example of a management table maintained by the management server shown in FIG. 2;

FIG. 6 shows a timing chart illustrating an example of work flow for registering a user's template;

FIG. 7A shows an example of registered information for a user's template;

FIG. 7B show an example of a user's template; and

FIG. 8 shows a timing chart for an example of work flow in a process for generating a schedule document, according to an exemplary embodiment of this disclosure;

FIG. 9A show an example of a user interface for selecting a user's template; and

FIG. 9B show a graphical representation of a user's template selected using the user interface in the example of FIG. 9A; and

FIG. 10 shows a flow chart for a schedule document generation process.

### DETAILED DESCRIPTION

This disclosure provides tools that can be utilized to automate the process for generating a schedule document based on mashup of data obtained from a plurality of different applications.

The term “mashup” in this disclosure is used in its broadest sense to refer generically to any process or application that can combine information or content from disparate applications or sources into, for example, a single document, file, page, graphical representation or interface, other presentation, etc., preferably in a format selected or specified by the user. There are many IT or programming tools that facilitate mashup, such as APIs (application programming interfaces), application development environments (such as Visual Studio®, etc.), dynamic languages (such as XML, Javascript, DHTML, etc.), Web-protocols (such as RSS, REST, Web Services, etc.), etc. Such techniques allow the content aggregation to take place at the server or on the client end. The techniques for performing mashup are well-understood in the art and therefore a detailed discussion of such techniques is not included herein, in the interest of brevity and clarity with regard to the aspects of this disclosure that are thought to be inventive.

In describing preferred embodiments and examples illustrated in the drawings, specific terminology is employed for the sake of clarity. However, such description in this disclosure is not intended to be limited to the specific terminology so selected and it is to be understood that each specific element includes all technical equivalents that operate in a similar manner. In addition, detailed descriptions of known functions and configurations will be omitted when they may obscure the inventive aspects of this disclosure.

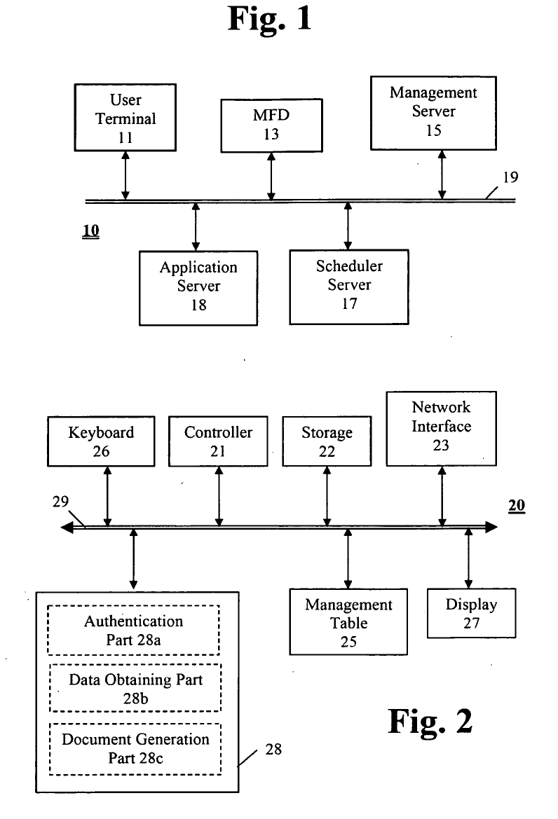

Referring now to the drawings, wherein like reference numerals designate identical or corresponding parts throughout the several views, FIG. 1 shows schematically an example of a system wherein a user, when properly authenticated and using a terminal, can access information, documents, data and other content, and obtain a schedule document that includes information from a plurality of applications and/or other information/data sources (for example, databases, document stores, etc.).

System 10, as shown in FIG. 1, includes a user terminal 11, multi-function device 13, management server 15, scheduler server 17 and application server 18, interconnected through network 19. It should be appreciated that FIG. 1 merely shows an example and that various variations are possible. For example, while the system shown in FIG. 1 includes one user terminal 11 and one application server 18, it should be appreciated that such numbers of terminal and application are arbitrarily selected as an example in order to facilitate discussion, and that the subject matter of this disclosure can be implemented in a system including one or more terminals and one or more applications (in addition to the scheduler application). Further, it should be understood that while the multi-function device 13 is shown in the system 10 as a system component separate from the user terminal 11 and the management server 15, the multi-function device can optionally serve as a user terminal and/or as the management server as well (assuming the device has adequate, processing, storage and communication resources). In addition, while separate computing devices are typically used for the management server 15, scheduler server 17 and application server 18, it should be understood that one computer (with adequate processing, storage and communication resources) can optionally provide the hardware platform for two or more of the servers.

The network 19 can include one or more of a local area network, a wide area network, the Internet, other communications links (such as a virtual private network, a wireless link, etc.), or a combination thereof. In addition, the network 15 preferably uses TCP/IP (Transmission Control Protocol/Internet Protocol), but other protocols can also be used. Each of the devices connected to the network 19 is configured with an appropriate network interface to enable the device to communicate with other devices connected to the network. How devices can connect to and communicate over the network 19 is well-known in the art and therefore in the interest of brevity and clarity, a detailed discussion of such network connection and communication is omitted. Instead, the reader is referred to, for example, “How Networks Work”, by Frank J. Derfler, Jr. and Les Freed (Que Corporation 2000) and “How Computers Work”, by Ron White, (Que Corporation 1999), the entire contents of each of which are incorporated herein by reference.

The management server 15 can be configured to provide a user interface through the network 19 to the user terminal 11 through which a user can enter user credential information, as well as other information. The management server performs user authentication by using the user credential information.

FIG. 2 shows an exemplary constitution of various components of a server computer 20 that can be configured through software as the management server 15. As shown in FIG. 2, server 20 includes a controller (or central processing unit) 21 that communicates with a number of other components, including memory or storage part 22, network interface 23, keyboard 26 and display 27, by way of a system bus 29.

The server 20 may be a special-purpose device (such as including one or more application specific integrated circuits or an appropriate network of conventional component circuits) or it may be software-configured on a conventional personal computer or computer workstation with sufficient memory, processing and communication capabilities to operate as a server.

In server 20, controller 21, memory/storage 22, network interface 23, keyboard 26 and display 27 are conventional except as discussed below, and therefore in order to avoid occluding the inventive aspects of this disclosure, such conventional aspects will not be discussed in detail herein.

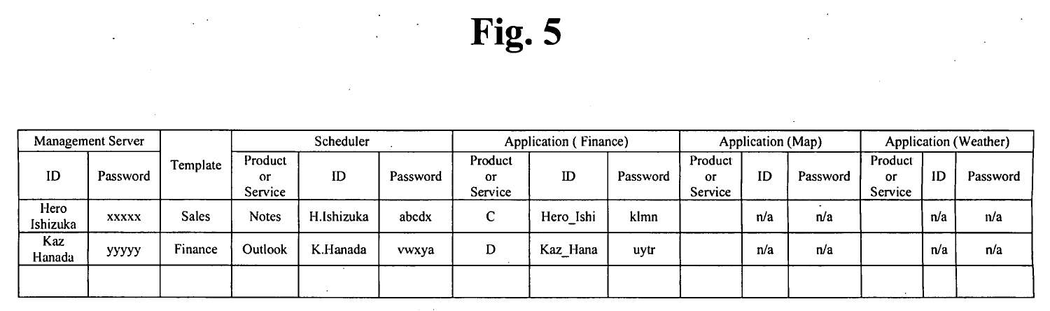

The controller 21 executing program code instructions controls server operations, including maintaining a management table 25 (example of which is shown in FIG. 5) and providing schedule document generator 28 functionality.

The management server 25 registers user authentication information in the management table 25. The registered user authentication information may include user identification and password for logging in to the management server as well as such (or other) authentication information for one or more applications or information/data sources. It should be appreciated that login need not necessarily include entry of a password, but other authentication measures, such as biometrics means (for example, comparing fingerprints, palm prints, voice or speech patterns, retinas or irises, facial expressions or features, signature, etc.), may alternatively be used.

Software-configured apparatus 28 generates a schedule document based on mashup of data obtained from a plurality of different applications. The apparatus 28 comprises an authentication part 28a, a data obtaining part 28b and a document generation part 28c.

The authentication part 28a performs authentication based on login information of the user and the registered information in the management table 25). Once the user is authenticated, the user, at a user terminal, can be provided, by the management server through a user interface at the terminal, with the options of (a) creating a schedule template or (b) retrieving a user template previously specified by the user. If option (a) is selected, the user is provided through the user interface with means to select or specify a starting document template, a desired scheduler application (such as Lotus Notes, MS Outlook/Exchange, etc.) and other applications. After the user makes the desired selections, information identifying the selected scheduler application, information identifying the selected additional applications and information identifying the selected document template, are stored in the management table 25.

On the other hand, if option (b) is selected, the data obtaining part 28b utilizes the registered authentication information of the user to obtain appropriate schedule data, previously entered for the user for a specified date in a scheduler application, from the scheduler application. For example, the obtaining part 28b utilizes the pre-stored authentication information of the user to login to the scheduler application, and then upon login to the scheduler application, the data obtaining part obtains the schedule data of the user from the scheduler application for the specified date.

In addition, the data obtaining part 28b obtains different information from one or more additional applications for populating data items of the schedule document, through a network connection (for example, the network 19 in FIG. 1) For example, the schedule data obtained from the scheduler application may include links to one or more of the other applications, and the data obtaining part utilizes the links to obtain information from the applications.

In another example, the data obtaining part extracts location data from the schedule data obtained from the scheduler application, and supplies the location data to one of the additional applications to obtain location-based information from the application. Such other applications may include a map application, and location-based map, directions and traffic information may be obtained from the map application and used when generating the image data for the schedule document. In addition, wherein the location information be used to obtain weather information from a weather application, and the schedule document in such instance would include the weather information.

The document generation part 28c generates and outputs image data for the schedule document by performing a mashup of the schedule data and the different information obtained from the one or more additional applications. The image data output by the document generation part may be utilized to output a schedule document to the user terminal or output a print job to a printing device to obtain a hardcopy of the schedule document.

In the example shown in FIG. 2, the management server 20 includes the network interface 23 for communications through a network, such as communications through the network 19 with the terminal 11, MFD 13, scheduler server 17 and/or application server 18 in FIG. 1. However, it should be appreciated that the subject matter of this disclosure is not limited to such configuration. For example, the management server may communicate with the other devices through direct connections and/or through a network to which the user terminal is not connected. As another example, the management server need not be provided by a server that services client terminals, but rather may communicate with the terminal on a peer basis, or in another fashion.

In a preferred embodiment, the management server can be configured to provide the herein-mentioned schedule document generation service and template creation service as web services. Supplying applications as web services is well-known in the art and therefore in the interest of brevity and clarity, a detailed discussion of such network connection and communication is omitted. Instead, the reader is referred to, for example, “Web Services Architecture”, W3C Working Group (11 Feb. 2004; http://www.w3.org/TR/2004/NOTE-ws-arch-20040211/), the entire contents of which are incorporated herein by reference.

The user terminal 11 configured with software (for example, a browser) allowing the user terminal to communicate through the network 19 with the management server 15 can receive a user interface from the management server through which a user can enter user credential information (which may or may not be stored locally). After the user credential information has been authenticated, the user terminal 11 communicating with the management server 15 through the network 19 can transmit a schedule retrieval request to the management server.

The user terminal 11 can be any computing device, including but not limited to a personal, notebook or workstation computer, a kiosk, a PDA (personal digital assistant), a mobile or smart phone or handset, another information terminal, etc., that can communicate through the network 19 with other devices. Although only one user terminal is shown in FIG. 1, it should be understood that the system 10 can include a plurality of user terminal devices (which can have similar or different configurations).

The terminal 11 can interact (exchange data) with the management server 15 via the network 19, so as to benefit from the services provided by the server. For example, a schedule retrieval request can be sent from the terminal 11 to the management server 15. As another example, the terminal 11 can transmit other information as well, such as, for example, user identification, password, the name of the person operating the terminal, etc.

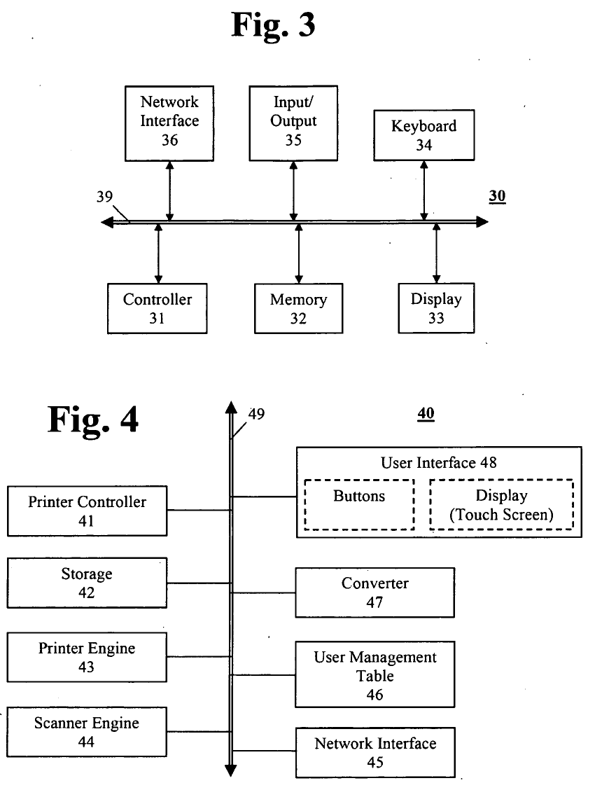

An example of a configuration of the user terminal (for example, as a computer) is shown schematically in FIG. 3. In FIG. 3, user terminal 30 includes a controller (or central processing unit) 31 that communicates with a number of other components, including memory 32, display 33, keyboard (and/or keypad) 34, other input/output (such as mouse, touchpad, stylus, microphone and/or speaker with voice/speech interface and/or recognition software, etc.) 35, network interface 36 and print driver 37, by way of internal bus 39.

The memory 32 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 36 provides a connection (for example, by way of an Ethernet connection or other network connection which supports any desired network protocol such as, but not limited to TCP/IP, IPX, IPX/SPX, or NetBEUI) to network 19.

A user interface is provided and is configured through software natively or received through a network connection, to allow the user to access electronic data or content on the terminal and/or via the network, interact with network-connected devices and services, enjoy other software-driven functionalities, etc. For example, a browser (such as Internet Explorer™, Netscape Navigator™, a proprietary browser, etc.) may be provided on the terminal so that a user of the terminal can use browsing operations to communicate with the management server 15 and/or access other data or content.

Additional aspects or components of the user terminal 30 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

As mentioned above, the user terminal 11 is not limited to a personal computer, but can be manifested in a form of any of various devices that can be configured to communicate over a network and/or the Internet.

FIG. 4 shows an example of a multi-function device (MFD) or multi-functional peripheral device (MFP) which includes scanning and printing functions, and additionally can serve as a user terminal for entering, saving and accessing electronic data or documents. In addition, as mentioned above, while the user terminal 11 and management server 15 are shown in FIG. 1 as distinct components, it should be understood that such components can be resident within a MFP device.

MFD apparatus 40 shown in FIG. 4 includes a controller 41, and various elements connected to the controller 41 by an internal bus 49, including storage 42 (for example, random access memory, read-only memory, hard disk drive, portable storage media drive such as for optical discs, magnetic discs, magneto-optical discs, etc., semiconductor memory cards, combinations of storage media, etc.), printer engine 43, scanner engine 44, network interface (I/F) 45, converter 47 for converting data from one format to another format (for example, a format suitable for printing, faxing, e-mailing, etc.), and user interface 48. The controller 41 controls and monitors operations of the MFP 40, and utilizes information stored in user management table 46 to authenticate the user and control user access to the functionalities of the MFP.

Storage 42 can include one or more storage parts or devices, and program code instructions can be stored in one or more parts or devices of storage 42, and retrieved and executed by the controller 41 to carry out the instructions. Such instructions can include instructions for performing specified functions (such as printing, scanning, faxing, copying, e-mailing, etc.) of the MFP, enable the MFP to interact with a terminal and/or the management server, as well as perhaps other external devices, through the network interface 45, and to control the converter 47, access data in the user management table 46, and interactions with users through the user interface 48.

The user interface 48 includes one or more display screens that display, under control of controller 41, information allowing the user of the MFP 40 to interact with the MFP. The display screen can be any of various conventional displays (such as a liquid crystal display, a plasma display device, a cathode ray tube display, etc.), but preferably is equipped with a touch sensitive display (for example, liquid crystal display) and is configured to provide a GUI (graphical user interface) based on information input by an operator of the MFP, so as to allow the operator to interact conveniently with services provided on the MFD, or with the MFD serving as terminal for accessing electronic data or other content through the network. For example, a browser (such as Internet Explorer™, Netscape Navigator™, a proprietary browser, etc.) may be provided on the MFD so that the operator can use browsing operations to access a database in system 10. As another example, the operator can scan a document, and use the browser to upload the image data from scanning of the document (and specify additional information associated with the image) to a database.

The display screen does-not need to be integral with, or embedded in, a housing of the MFP, but may simply be coupled to the MFP by either a wire or a wireless connection. The user interface 48 may include keys and/or buttons (such as graphical keys or buttons, or other graphical elements, of a GUI on a touchscreen display) for inputting information or requesting various operations. Alternatively, the user interface 48 and the display screen may be operated by a keyboard, a mouse, a remote control, voice recognition, or eye-movement tracking, or a combination thereof.

Since the MFP 40 is typically shared by a number of users, and is typically stationed in a common area, the MFP preferably prompts the user to supply user credential or authentication information, such as user name (or other user or group information), password, access code, etc. The user credential or authentication information can be compared to data stored in the user management table 46 to confirm that the user is authorized to use the MFP. The user credential or authentication information may also be stored for the session and automatically supplied if access to other devices through the network requires it. On the other hand, such other devices may prompt the user to supply other user credential or authentication information through the user interface. In any event, it should be appreciated that the management table 46 can be expanded to include functions similar to the functions of management table 25 maintained by the management server 20, particularly when the MFD device is configured to serve as the management server in the system.

Other methods of authentication may also be used. For example, the multi-function device may be equipped with a card reader or one or more biometrics means (such as comparing fingerprints, palm prints, voice or speech, retinas or irises, facial expressions or features, signature, etc.).

Printer engine 43, scanner engine 44 and network interface 45 (similar to interface 23 in FIG. 2 and interface 36 in FIG. 3) are otherwise conventional, and therefore, a detailed description of such conventional aspects are omitted in the interest of clarity and brevity (so as not to mask the novel aspects of the subject matter of this disclosure).

The MFD 40 can have any or all of the functions of similar devices conventionally known, such as for scanning, editing and storing images, sending a fax, sending and receiving e-mails with or without attachments, accessing files by FTP or another protocol or facility, surfing the Web, etc. Further, multi-functional devices or multi-function peripheral devices can play a prominent role to convert hardcopy documents to electronic documents.

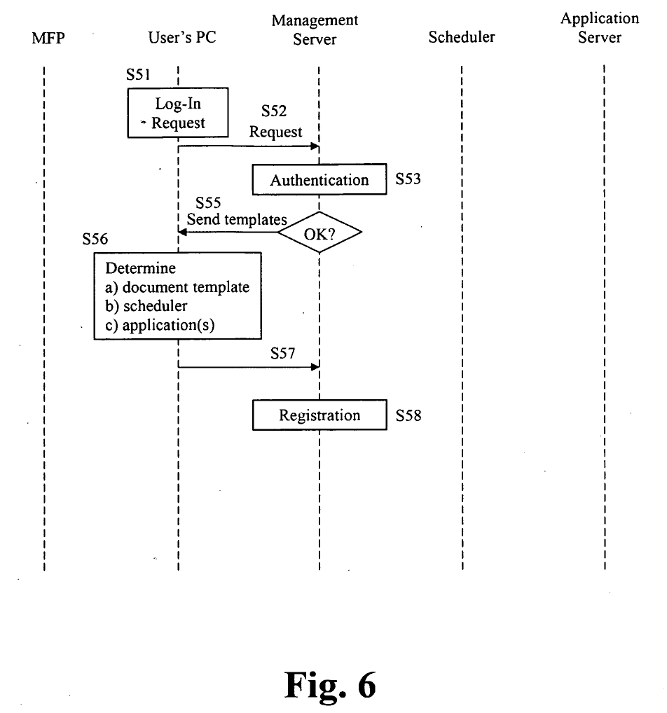

A typical workflow for registering a user's template will be explained with reference to FIGS. 1 and 6. When a user enters login information, such as ID and password, on the user terminal 11 to request access to the management server 15 (step S51), the login request is transmitted along with the login information to the management server 15 (step S52). The management performs authentication of the user by comparing the login information received from the user to the authentication information registered in the management table 25 (step S53). If the user is authenticated, a user interface is transmitted to the user terminal (step S55) to allow the user to select a document template as a starting point for forming the user's schedule template, select a scheduler application and select one or more applications or other information/data sources from which data is to be obtained to populate the schedule document (step S56). The user template formed by the user selections or specifications is communicated to the management server 15 (step S57) and registered in the management table (step S58).

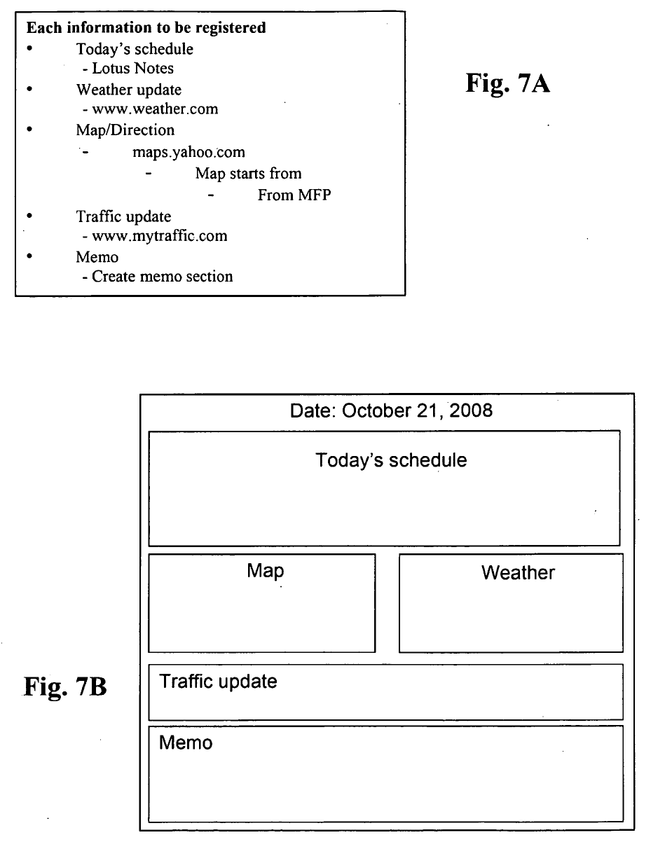

FIGS. 7A and 7B shows an example of registered information and registered user's template. The user's template, as shown in FIG. 7B, indicates the different data fields to be included in, and the approximate layout of, the schedule document. In the example of FIGS. 7A and 7B, the user's template includes a map section, a weather section, a traffic section and a memo section, in addition to the schedule section. The registered information (FIG. 7A) indicates that the schedule data is to be obtained from Lotus Notes application, weather information is to be obtained from www.weather.com, map information is to be obtained from maps.yahoo.com, traffic information is to be obtained from www.mytraffic.com. Such registered information indicates the sources from which the information is to be obtained for populating the schedule document.

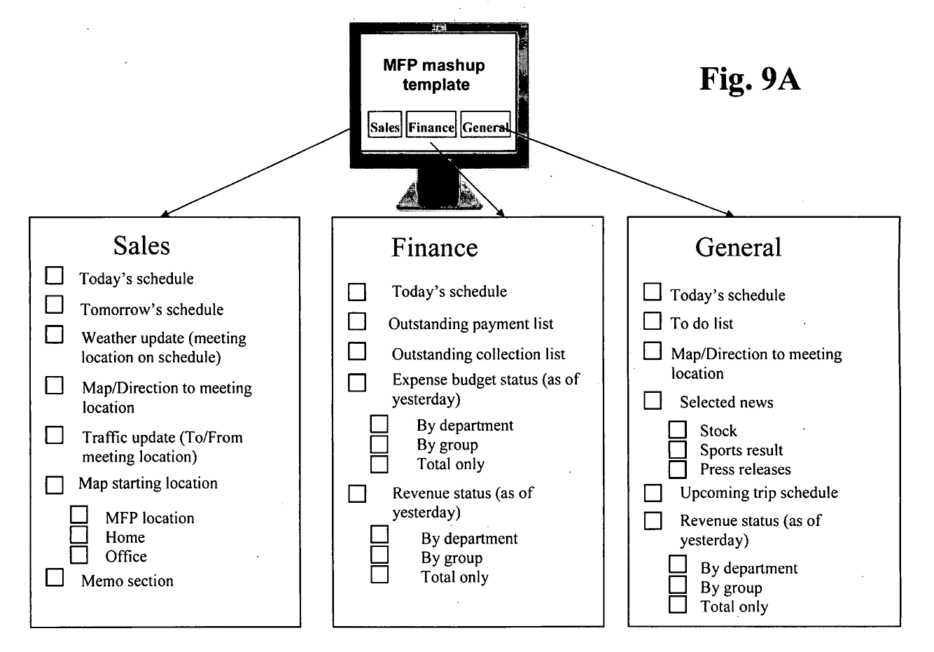

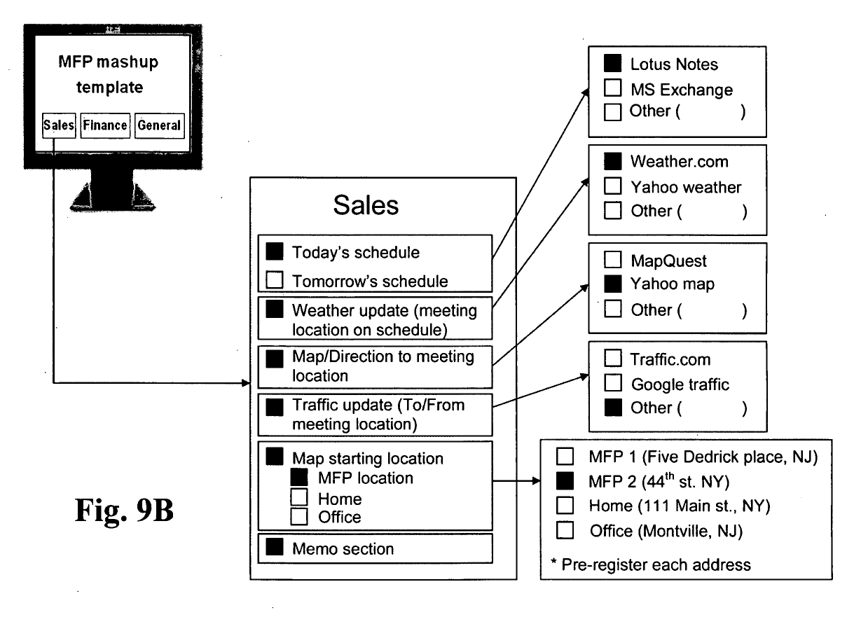

An example of a user interface that can be provided for selecting a user's template is shown in FIGS. 9A and 9B. In the example of FIGS. 9A and 9B, the user (after login and authentication) is provided with a choice of document templates (Sales, Finance, General, etc.). Each document template is different from the others.

For example, the Sales template caters to the schedule and activities of a member of the sales department who spends much time away from the home office. Thus, such user may sometimes wish to obtain tomorrow's schedule (alternatively, the choice defaults to today's schedule). Further, such member, for purposes of travelling to locations away from the office, typically would like to have one or more of map, directions, traffic and weather information for the location to which the member is travelling. In addition, the sales department member may start the schedule from any of multiple locations (such as home, office, site of the MFP, etc.) and thus the user is allowed to choose the starting location.

A graphical representation of a user's template selected using the Sales template is shown in FIG. 9B. For example, when the user selects the Today's schedule entry in the Sales template, the user is provided with a choice of scheduler applications (for example, Lotus Notes, MS Exchange, other, etc.). Additionally, the user is provided with means to select any of multiple choices (for example, location of the MFP, home, office, etc.) for a starting location for maps/directions.

On the other hand, the Finance template is catered to the concerns of a typical member of the finance department who spends most of work hours at the office. Such member is concerned with payments, collections, expense and budget, revenue, etc. Thus, the Finance template allows a user who is in the finance department to include selected ones of such information in the printed document.

As another option provided to the user, the General template provides an assortment of categories of information that can be selected. For example, in addition to the items that can be selected from the Sales template or Finance template, the General template may allow the user to select a to-do list, news, etc.

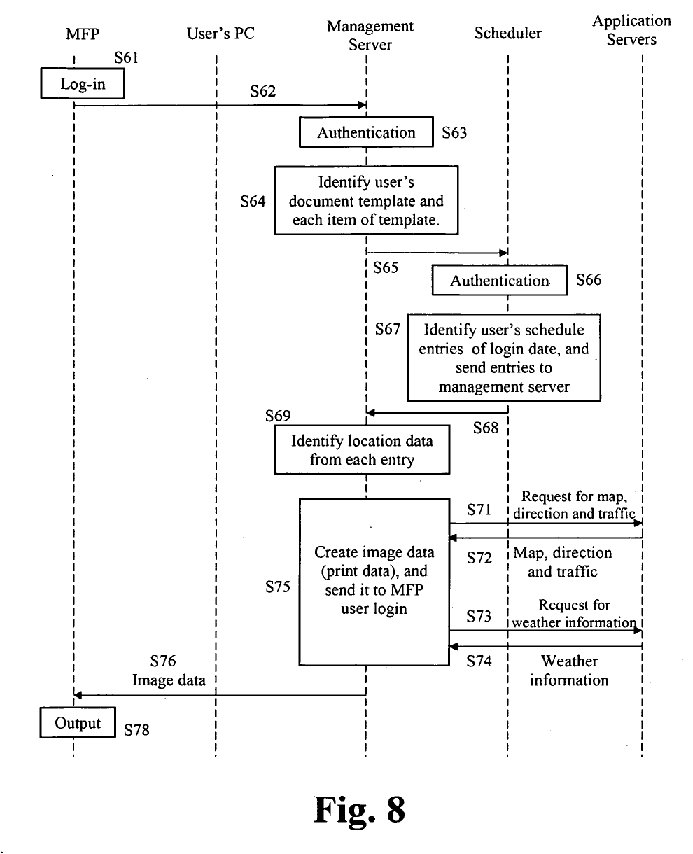

An example of a typical work flow in a process for generating a schedule document, according to an exemplary embodiment of this disclosure, is explained below with reference to FIGS. 1 and 8. As with the registration process, the workflow is triggered by user login (step S61), transmission of login information to the management server (step S62), and authentication of the use (step S63), except that the login is typically performed from the MFP. If the user is not authenticated (for example, ID or password is not correct), an error message may be transmitted to the MFP to alert the user to the error.

After the user is authenticated, the management server retrieves the user's template and registered information of the authenticated user from the management table (step S64). The retrieved information may also include authentication information for login to the scheduler application and in such instance the authentication information is transmitted along with a specified date (for example, login date) and a request for the user's schedule data, to the scheduler application (step S65). After the request is authenticated by the scheduler application (step S66), the scheduler retrieves the user's schedule data for the specified date (that is, each schedule entry bearing the specified date) (step S67) and transmits the schedule data to the management server (step S68)

Most schedulers provide a location field in each schedule entry, and thus, the management server can extract location information from each schedule entry (step S69) and transmit the location information to one or more applications that provide location-based information. For example, the management server transmits a request for map, direction and traffic information to a map application (maps.yahoo.com in the example of FIGS. 7A and 7B) accompanied by the location information (step S71), and the map application responds with the requested information (step S72). In addition, the management server may transmit a request for weather information to a weather application (www.weather.com in the example of FIGS. 7A and 7B) accompanied by the location information (step S73), and the weather application responds with the requested information (step S74).

The management server generates image data for the schedule document, by utilizing the schedule data received from the scheduler application, the map, direction and traffic information from the map application and the weather information from the weather application (step S75), and transmits the image data to the MFP (step S76). The MFP prints the schedule document based on the received image data.

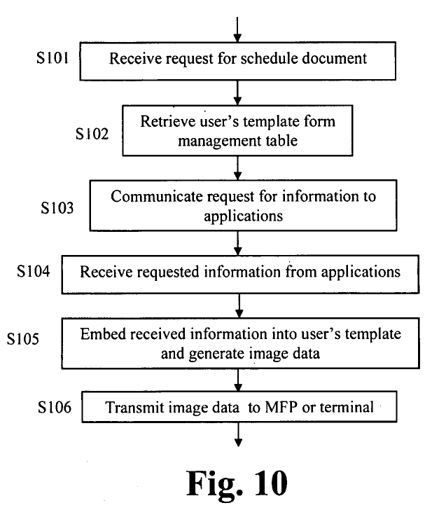

A schedule document generation method, in accordance with an exemplary embodiment of this disclosure, is explained below with reference to FIG. 10.

When the user requests output of a schedule document (step S101), the registered user's template is retrieved from the management table (step S102). The linked applications are determined from the user's template, and requests for map, direction and traffic information and for weather information are communicated to the map and weather applications, respectively (step S103).

As discussed above, the user's template can include the starting location, and such information can be used as the starting information transmitted to the map application and the location information extracted from the schedule data can be used to specify the destination to the map application. Further, the login date and time, by default, can be specified as the date and time. On the other hand, many of the scheduler application include the date and time in the schedule data, and such information can therefore be extracted from the received schedule data.

When the requested information is received from the applications (step S104), the received information is embedded into each field of the user's template document and then image data is generated (step S105). The image data is transmitted to the MFP or terminal from which the schedule document requested was transmitted (step S106).

In the typical workflow as discussed above, the user uses, from a terminal, a template creation service provided by the management server through a network (for example, as a web service) to create a document template that is to be used for generating a schedule document and selects the applications from which information/data is to be obtained for populating the schedule document. Such generation of a template can be performed at any time.

At a later time, the user can obtain a schedule document based on such template. For example, the user can log on to MFP using an operation panel of the MFP, then select “Today's schedule” to obtain a hardcopy of today's schedule with most recent weather and traffic schedule. Such approach does not require the user to login to the user personal computer to find schedule, map/direction and weather and print. Instead, the user can just walk up to the MFP and select his/her schedule to print up-to-date complete information.

In the case that the management service is provided as a web service, the management table as well as other related information are maintained by the web service. The web service is configured to communicate with the selected scheduler application as well as other selected applications and information/data sources (for example, databases, document stores, etc.). Regardless of where the user is, the user can access schedule information if there is a MFP with mashup connection.

It should be appreciated that while specific applications are referenced herein, the subject matter of this disclosure is not limited to the referenced applications and that the schedule document generation service described herein can be utilized with mashup of other applications as well.

The above specific examples and exemplary embodiments are illustrative, and many variations can be introduced on these embodiments without departing from the spirit of the disclosure or from the scope of the appended claims. For example, elements and/or features of different examples and illustrative embodiments may be combined with each other and/or substituted for each other within the scope of this disclosure and appended claims.

What is claimed is:

1. An apparatus for generating a schedule document based on mashup of data obtained from a plurality of different applications, said apparatus comprising:
a management information storage part configured to register authentication information of a user;
an authentication part configured to perform authentication based on login information of the user;
a data obtaining part configured to utilize the registered authentication information of the user to obtain appropriate schedule data for the user for a specified date from a scheduler application and configured to obtain different information from one or more additional applications for populating data items of the schedule document; and
a document generation part configured to generate and output image data for the schedule document by performing a mashup of the schedule data and the different information obtained from the one or more additional applications.

2. The apparatus as claimed in claim 1, wherein said data obtaining part utilizes the pre-stored authentication information of the user to login to the scheduler application, and then upon login to the scheduler application, the data obtaining part obtains the schedule data of the user from the scheduler application for the specified date.

3. The apparatus as claimed in claim 1, wherein said data obtaining part determines the scheduler application, the one or more additional applications and a document template, for the user, and stores user template information identifying the scheduler application, identifying the one or more additional applications and identifying the document template, in a management table.

4. The apparatus as claimed in claim 1, wherein the schedule data obtained from the scheduler application includes a link to one of the additional applications, and said data obtaining part utilizes the link to obtain information from the one of the additional applications.

5. The apparatus as claimed in claim 1, wherein said data obtaining part extracts location data from the schedule data obtained from the scheduler application, and supplies the location data to one of the additional applications to obtain location-based information from the application.

6. The apparatus as claimed in claim 1, wherein said data obtaining part extracts location information from the schedule data obtained from the scheduler application, and transmits the location information to a map application to obtain location-based information from the map application, and said document generation part utilizes the location-based information when generating the image data for the schedule document.

7. The apparatus as claimed in claim 6, wherein the image data generated utilizing the location-based information includes at least one of a map, directions and traffic information.

8. The apparatus as claimed in claim 1, wherein said data obtaining part extracts location information from the schedule data obtained from the scheduler application, and transmits the location information and the specified date to a weather application to obtain weather information from the weather application, and the image data generated by said document generation part for the schedule document includes the weather information.

9. The apparatus of claim 1 further comprising:
an information communication part configured to communicate a print job, including the image data output by the document generation part, through a network to a printing device.

10. A multi-function device for generating a schedule document based on mashup of data obtained from a plurality of different applications, said multi-function device comprising:
an authentication information storage part configured to register authentication information of a user;
an authentication part configured to obtain login information of the user and perform authentication based on the login information;
a data obtaining part configured to utilize the registered authentication information of the user to obtain appropriate schedule data for the user for a specified date from a scheduler application and obtain different information from one or more additional applications for populating data items of the schedule document;
a document generation part configured to generate and output image data for the schedule document by performing a mashup of the schedule data and the different information obtained from the one or more additional applications; and
a printing part configured to print the schedule document, utilizing the image data output by the document generation part.

11. A method for generating a schedule document, based on mashup of data obtained from a plurality of different applications, said method comprising:
(a) obtaining schedule data of a user for a specified date from a scheduler application and obtaining different information from a plurality of additional applications for populating a plurality of data items of the schedule document; and
(b) generating and outputting image data for the schedule document by performing a mashup of the schedule data and the different information obtained from the plurality of additional applications.

12. The method as claimed in claim 11, further comprising:
extracting location data from the schedule data obtained in (a), and supplying the location data to one or more of the plurality of additional applications to obtain location-based information from the additional application.

13. The method as claimed in claim 11, further comprising: utilizing pre-stored authentication information of the user to login to the scheduler application, and after login, the schedule data of the user for the specified date is obtained in (a).

14. The method as claimed in claim 11, wherein the schedule data obtained from the scheduler application in (a) includes a link to one of the plurality of additional applications, and the link is utilized to obtain information from the one of the plurality of additional applications in (a).

15. The method as claimed in claim 11, further comprising:
extracting location information from the schedule data obtained in (a);
transmitting the location information to a map application and obtaining location-based information from the map application; and
utilizing the map information when generating the image data in (b).

16. The method as claimed in claim 11, further comprising:
extracting location information from the schedule data obtained in (a);
transmitting the location information and the specified date to a weather application and obtaining weather information from the weather application; and
utilizing the weather information when generating the image data.

17. The method as claimed in claim 11, further comprising:
printing the schedule document utilizing the image data generated based on the mashup of the schedule data and the different information obtained from the plurality of additional applications.

18. The method as claimed in claim 11, further comprising:
(c) obtaining login information of a user and performing user authentication;
(d) providing the user with a user interface to select one of a plurality of scheduler applications, select other applications and select a document template; and
(e) storing user template information identifying the selected scheduler application, the selected other applications and the selected template, in a management table.

19. The method as claimed in claim 11, further comprising:
presenting a plurality of document templates for schedule documents, for selection by the user,
wherein the document template is selected in (d) from the plurality of document templates.
